(19) United States
(12) Patent Application Publication
(10) Pub. No.: US 2025/0012421 A1
(43) Pub. Date: Jan. 9, 2025

(54) VEHICULAR LAMP

(71) Applicant: ICHIKOH INDUSTRIES, LTD., Isehara-shi (JP)

(72) Inventors: Kenji MATSUOKA, Isehara-shi (JP); Kunihiro SHIMIZU, Isehara-shi (JP)

(73) Assignee: ICHIKOH INDUSTRIES, LTD., Isehara-shi (JP)

(21) Appl. No.: 18/704,736

(22) PCT Filed: Oct. 25, 2022
(86) PCT No.: PCT/JP2022/039696

§ 371 Date: Apr. 25, 2024

(30) Foreign Application Priority Data
Oct. 29, 2021 (JP) 2021-177998

(51) Int. Cl. F21S 45/47

(52) U.S. Cl. CPC F21S 45/47

(57) ABSTRACT

A vehicular lamp capable of sufficiently dissipating heat from a light source, while securing an attachment strength of a board to a heat dissipation member. The vehicular lamp includes a board that is electrically connected to the light source; and the heat dissipation member for dissipating heat from the light source, including an installation surface on which the board is placed. The heat dissipation member further includes a projection portion that projects from the installation surface and a contact surface that is opposite to the installation surface and is formed into a flat surface. The board includes an opening portion that allows the projection portion to pass therethrough. The contact surface is positioned, in an optical axis direction, on the same straight line on which the projection portion is positioned.

### CROSS-REFERENCE TO RELATED APPLICATION

This application is based upon and claims the benefit of priority from Japanese Patent Application No. 2021-177998 filed to the Japan Patent Office on Oct. 29, 2021, the entire disclosure of which is incorporated herein by reference.

### TECHNICAL FIELD

The present disclosure relates to a vehicular lamp.

### BACKGROUND ART

Vehicular lamps are required to use light sources with high output and high luminance. For this reason, in vehicular lamps, those efficiently dissipating heat from the light source have been devised (see, for example, JP6171269B, JP2021-64572A etc.).

The vehicular lamp of JP6171269B is that a board on which a light source has been mounted is attached to a thin plate-shape metal body, and then the metal body is integrally embedded in a socket (heat-conductive resin member) by insert molding. With this, heat from the light source can be dissipated from the metal body through the socket.

The vehicular lamp of JP2021-64572A is that a board on which a light source has been mounted is attached to a conic metal body (heat conductive part), and then the metal body is inserted into a recess (storage part) of a socket. With this, heat from the light source can be dissipated from the metal body through the socket.

### SUMMARY

By the way, since vehicular lamps are subject to various vibrations, etc., it is sometimes required to increase the attachment strength of the board. However, in the vehicular lamp of JP6171269B, the board is adhered to the metal body through a heat conductive medium made of adhesive, grease, etc. In the vehicular lamp of JP2021-64572A, the board is installed on the metal body through a bonding layer made of adhesive. Therefore, these vehicular lamps may lack the attachment strength of the board, which may cause the board to drop off or to be misaligned.

The present disclosure was made in view of the above situation, and its object is to provide a vehicular lamp that is capable of sufficiently dissipating heat from the light source while securing the attachment strength of the board.

A vehicular lamp according to the present disclosure includes a board that is electrically connected to a light source; and a heat dissipation member for dissipating heat from the light source, including an installation surface on which the board is placed. The heat dissipation member further includes a projection portion that projects from the installation surface and a contact surface that is opposite to the installation surface and is formed into a flat surface. The board includes an opening portion that allows the projection portion to pass therethrough. The contact surface is positioned, in an optical axis direction, on the same straight line on which the projection portion is positioned.

### BRIEF DESCRIPTION OF THE DRAWINGS

FIG. 1 is an explanatory view showing a vehicular lamp of a first embodiment as a vehicular lamp according to the present disclosure. FIG. 2 is an explanatory view showing a light source unit of the vehicular lamp. FIG. 3 is an exploded explanatory view showing a configuration of the light source unit. FIG. 4 is an explanatory view showing a condition in which a heat dissipation member of the light source is seen from the back side. FIG. 5 is an explanatory view showing a condition in which a socket of the light source unit is seen from an attachment surface side. FIG. 6 is an explanatory view showing a section taken along the line I-I of FIG. 3. FIG. 7 is an explanatory view similar to FIG. 6, but showing a condition in which a circuit board is disposed on the heat dissipation member.

FIG. 8 is an explanatory view showing a condition in which projection portions are swaged from the condition of FIG. 7. FIG. 9 is an explanatory view showing a condition in which the heat dissipation member is pressed into the socket, corresponding to the section taken along the line II-II of FIG. 2. FIG. 10 is an explanatory view showing a condition in which protrusion portions are swaged from the condition of FIG. 9.

### DESCRIPTION OF EMBODIMENT

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

In the following, an embodiment of a vehicular lamp 10 as one example of a vehicular lamp according to the present disclosure is explained with reference to the drawings.

### First Embodiment

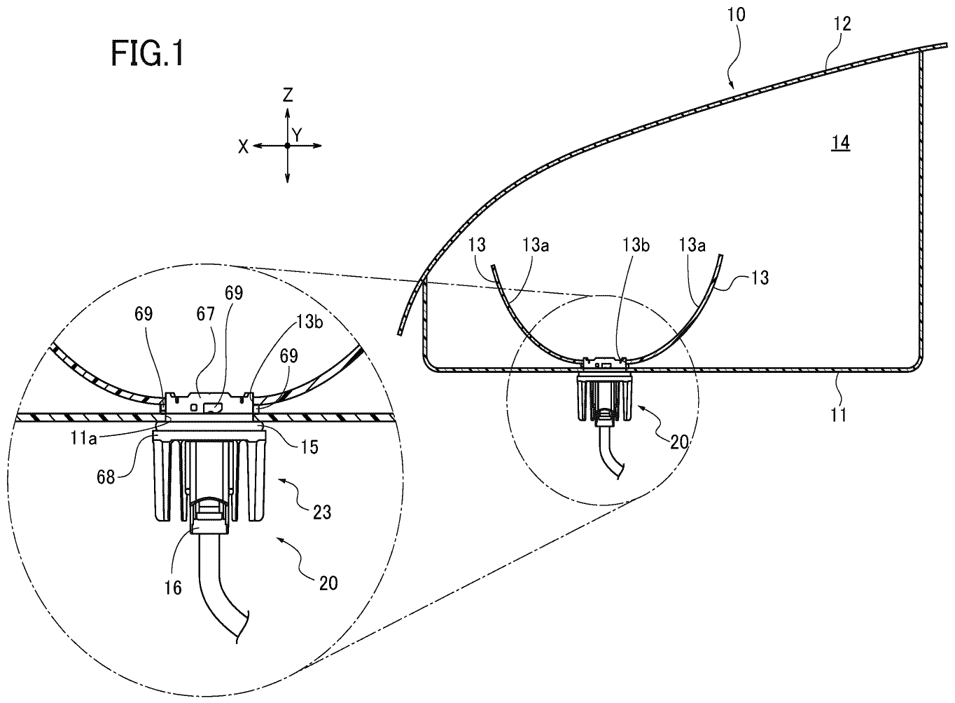

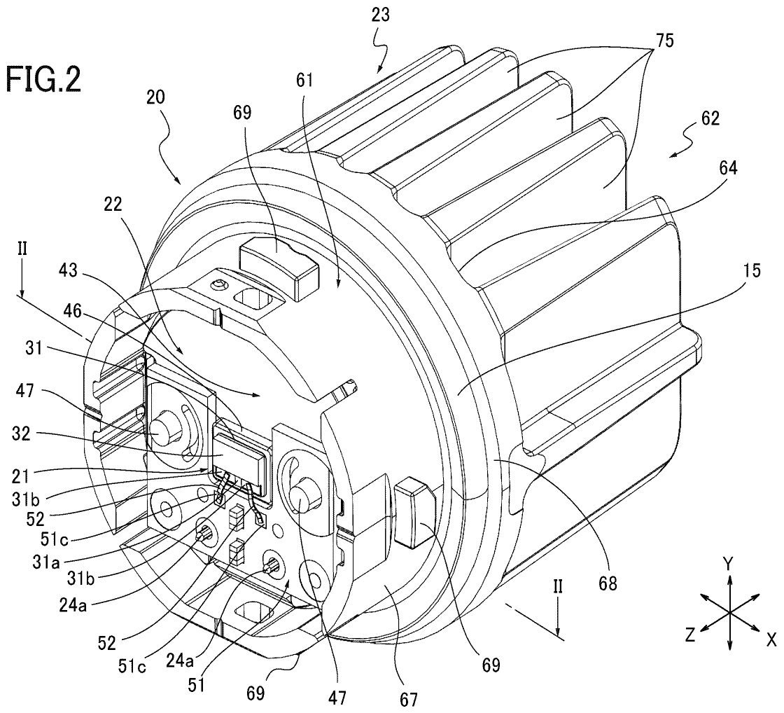

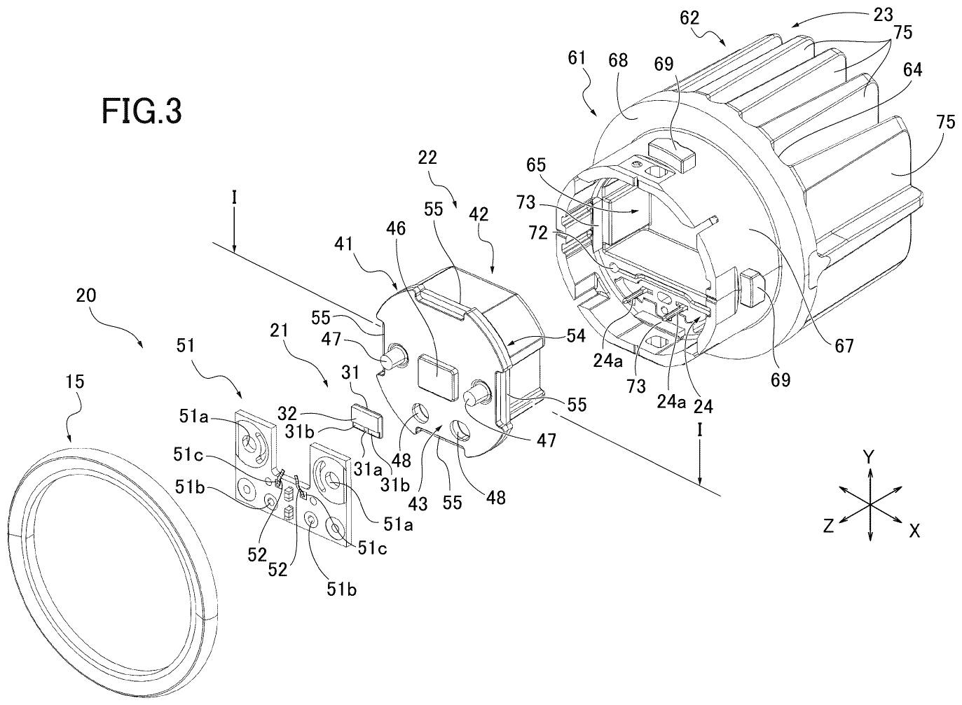

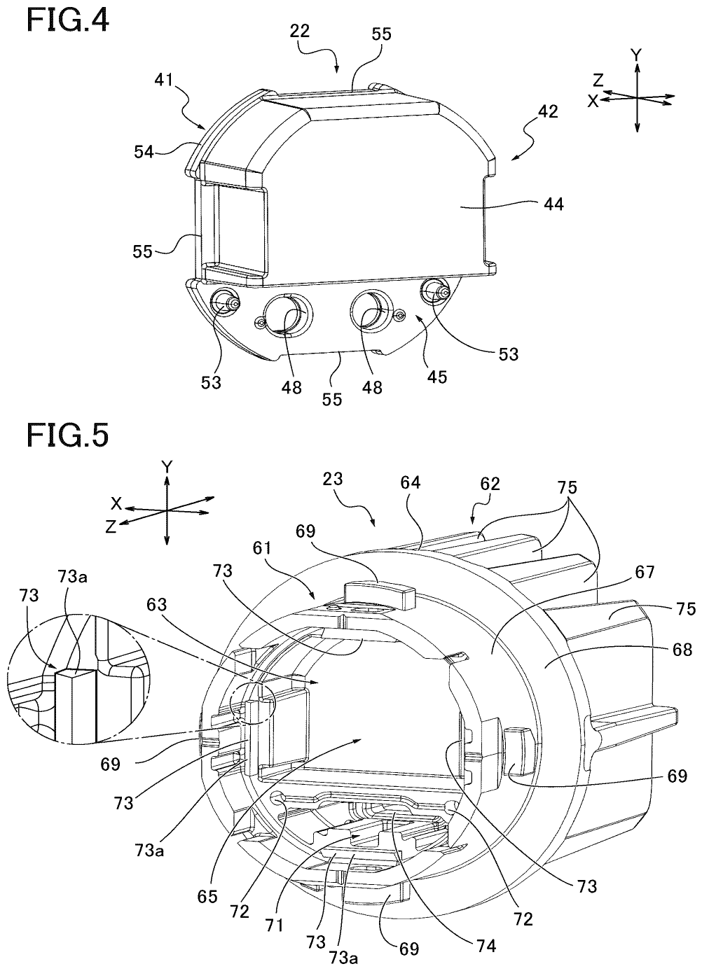

The vehicular lamp 10 of the first embodiment according to one embodiment of a vehicular lamp according to the present disclosure is explained by using FIG. 1 to FIG. 10. The vehicular lamp 10 of the first embodiment is used as a lamp for vehicles such as automobiles. For example, it is used for head lamps, fog lamps, daytime running lamps, clearance lamps, stop lamps, tail lamps, turning signal lamps, cornering lamps, etc. In the following explanation, in the vehicular lamp 10, the direction in which the vehicle travels straight and in which the light is emitted is defined as the optical axis direction (Z in the drawings, and the illuminated side is defined as the front side), the upward and downward directions when mounted on the vehicle are defined as the vertical directions (Y in the drawings), and directions that are perpendicular to the optical axis direction and the vertical directions are defined as the left-right directions (X in the drawings).

As shown in FIG. 1, the vehicular lamp 10 includes a lamp housing 11, a lamp lens 12, a reflector 13, and a light source unit 20. The lamp housing 11 is formed of a light non-transmissible member such as colored or painted resin material, and is open at the front and blocked at the rear. The lamp housing 11 is provided with an attachment hole 11a through the blocked rear end. An edge of this attachment hole 11a is provided with a plurality of notches and stoppers at generally even intervals.

The lamp lens 12 is formed of a light transmissible member such as a transparent resin member or glass member, and is shaped to cover an open front end of the lamp housing 11. The lamp lens 12 is fixed to an opening portion of the lamp housing 11 in a sealed condition to ensure watertightness. The lamp housing 11 and the lamp lens 12 form a light chamber 14 that is delimited by them.

The reflector 13 is a light distribution control member that distributes and controls the light emitted from the light source unit 20. It is fixed to the lamp housing 11, etc., and is disposed in the light chamber 14. The reflector 13 has a curved shape with a focal point near the light source 21 (see FIG. 2, etc.) of the light source unit 20, its inner surface is a reflective surface 13a that reflects light, and its bottom portion is provided with an attachment hole 13b. In a condition that the reflector 13 is disposed in the light chamber 14, the attachment hole 13b is in a positional relationship to match with the attachment hole 11a of the lamp housing 11. In the first embodiment, the reflector 13 is formed as a member separate from the lamp housing 11. However, it may be a one-piece configuration, that is, the inner surface of the lamp housing 11 may be used as the reflective surface, or any other configurations, and is not limited to the configuration of the first embodiment. Furthermore, instead of the reflector (reflective surface), a light guiding member may be provided on the front side in the optical axis direction of the light source unit 20 to emit light from a different position and in a different size region than those of the light source 21, and it is not limited to the configuration of the first embodiment. Even in case that a light guiding member is provided in this manner, the vehicular lamp 10 can be used, for example, as a head lamp, fog lamp, daytime running lamp, clearance lamp, stop lamp, tail lamp, etc.

In this light chamber 14, the light source unit 20 is disposed by passing through the attachment hole 11a of the lamp housing 11 and the attachment hole 13b of the reflector 13. The light source unit 20 is detachably attached to the attachment hole 11a with an interposal of a sealing member (O-ring) 15 between the light source unit 20 and the lamp housing 11. The light source unit 20 may be installed in the light chamber 14 via an optical axis adjustment mechanism for the vertical directions or for the left-right directions.

As shown in FIGS. 2 and 3, the light source unit 20 includes the light source 21, a heat dissipation member 22, a socket 23, and a feed member 24. The light source 21 is formed as a submount-type light emitting device with a light emitting chip 32 provided on a submount substrate 31. A mounting surface 31a of the submount substrate 31 is generally rectangular in shape, when viewed from the front in the optical axis direction, with the light emitting chip 32 attached to the upper half and with connection terminals 31b as a pair at two lower corners. In the light source 21, the light emitting chip 32 and both connection terminals 31b are electrically connected via the submount substrate 31 (its electrical path). When power is supplied between both connection terminals 31b, the light emitting chip 32 is turned on.

The light emitting chip 32 is a self-luminous semiconductor type light source such as an LED (Light Emitting Diode), EL (Organic EL), LD chip (Laser Diode chip), etc. In the first embodiment, it is an LED chip. The light emitting chip 32 is positioned near the focus of the reflector 13 in a condition that the light source unit 20 is installed.

The heat dissipation member 22 is a heat sink member that transfers heat generated by the light source 21 to the socket 23. It is formed of a metallic material high in thermal conductivity. In the first embodiment, it is formed by aluminum die casting among metal die castings. As shown in FIGS. 3 and 4, the heat dissipation member 22 includes an installation plate portion 41 and a massive portion 42. The installation plate portion 41 is formed into a plate shape that is perpendicular to the optical axis direction. In the first embodiment, it is formed into a rectangular shape with four rounded corners, when viewed in the optical axis direction. This installation plate portion 41 forms an installation surface 43, on the front side in the optical axis direction, with a flat surface that is perpendicular to the optical axis direction. The massive portion 42 is provided on the rear side in the optical axis direction of the installation plate portion 41. It is formed into a prismatic shape that projects toward the rear side from the installation plate portion 41 at a position biased toward the upper side in the vertical direction relative to the installation plate portion 41. Therefore, the massive portion 42 is formed into a metal mass (filled with metal) with a large thickness in the optical axis direction, thereby increasing thermal capacity of the heat dissipation member 22. This massive portion 42 forms a contact surface 44, on the rear side in the optical axis direction, with a flat surface that is perpendicular to the optical axis direction.

This massive portion 42 is made to exist at least beyond a center of the heat dissipation member 22 to a lower side in the vertical direction. In the first embodiment, it exists until a position that is generally two-thirds on an upper side in the vertical direction. Therefore, in the heat dissipation member 22, a step is formed between the installation plate portion 41 and the massive portion 42 on a rear side in the optical axis direction. The installation plate portion 41 is formed, on the rear side in the optical axis direction, with a part that is not provided with the massive portion 42 and is formed to have a flat surface perpendicular to the optical axis direction as an abutment surface 45. This abutment surface 45 is at a position that is below and on the front side of the contact surface 44, and is parallel with the contact surface 44.

The installation surface 43 is formed into a flat surface perpendicular to the optical axis direction and is provided with a projected surface portion 46, a pair of projection portions 47 and a pair of terminal holes 48. The projected surface portion 46 results from making a center of the installation surface 43 partially project to the front side in the optical axis direction and is provided at a position overlapped with the massive portion 42 in the optical axis direction. The projected surface portion 46 is formed at its projection end with a flat surface perpendicular to the optical axis direction, for installing thereon the light source 21. Therefore, of the installation surface 43, the projected surface portion 46 becomes a light source installation location where the light source 21 is installed. The light source 21 is attached to the projected surface portion 46 through an adhesive with thermal conductivity. This adhesive is one to attach the light source 21 (its submount substrate 31) to the projected surface portion 46. It is made of a material such as epoxy resin adhesive, silicone resin adhesive, acrylic resin adhesive, etc., and is in liquid form, fluid form, tape form, etc. In this way, the vehicular lamp 10 uses the submount-type light source 21. Therefore, it is possible to directly attach the light source 21 to the heat dissipation member 22, thereby effectively cooling the light source 21.

Both projection portions 47 are cylindrical, projecting from the installation surface 43 in the optical axis direction, and are provided as a pair so as to sandwich the projected surface portion 46 in the left-right directions. Each projection portion 47 is provided at a position overlapped with the massive portion 42 in the optical axis direction and is positioned, in the optical axis direction, on the same straight line on which the contact surface 44 (its portion) is positioned (see FIG. 6, etc.). Both terminal holes 48 are through holes that pass through the installation plate portion 41 below the projected surface portion 46 and allow pin terminals 24a (see FIGS. 2 and 3) of the feed member 24 to pass therethrough. Both terminal holes 48 are aligned in the left-right directions and open on the installation surface 43 and the abutment surface 45 in the optical axis direction.

On the installation surface 43, a board 51 is provided to surround an underside and both lateral sides of the projected surface portion 46, that is, the light source 21. This board 51 is one to transmit control signals from a control circuit mounted on the vehicle to the light source 21 and is suitably provided with a plurality of elements such as capacitors. The board 51 is a U-shaped plate member to surround the projected surface portion 46 and, when provided on the installation surface 43, has generally the same height as that of the projected surface portion 46 in the optical axis direction (see FIG. 7, etc.). Therefore, the installation surface 43 is formed, on the underside and both lateral sides of the projected surface portion 46, with a board installation location where the board 51 is installed. The board 51 may be provided with a control circuit, and is not limited to the configuration of the first embodiment.

The board 51 is provided with a pair of opening portions 51a, a pair of terminal connection holes 51b, and a pair of connection terminals 51c. Both opening portions 51a are through holes passing through the board 51 in the optical axis direction and make a pair to sandwich the light source 21 in the left-right directions. The opening portions 51a are respectively provided at positions corresponding to those of the pair of projection portions 47 and allow the corresponding projection portions 47 to pass therethrough. The terminal connection holes 51b are through holes that pass through the board 51 in the optical axis direction, are provided at positions corresponding to those of the pair of terminal holes 48 provided on the installation surface 43 of the heat dissipation member 22, and allow the pin terminals 24a of the feed member 24 to pass therethrough. Each terminal connection hole 51b is electrically connected with a circuit on the board 51 and is electrically connected with the feed member 24 by fixing the corresponding pin terminal 24a with solder, etc. Both connection terminals 51c are provided at positions corresponding to those of the connection terminals 31b on the mounting surface 31a of the submount substrate 31, and are electrically connected to the circuit formed on the board 51. This board 51 is attached to the installation surface 43 to have the above-mentioned positional relationship, through an adhesive with thermal conductivity.

The board 51 is electrically connected with the light source 21 by a pair of bonding wires 52 provided by wire bonding. The bonding wires 52 are provided as a pair to bridge each connection terminal 31b on the submount substrate 31 of the light source 21 attached to the projected surface portion 46 and each connection terminal 51c of the board 51 attached to the installation surface 43. In the first embodiment, each bonding wire 52 is electrically connected at its one end and the other end to the connection terminal 31b and the connection terminal 51c respectively, by wire bonding using ultrasonic waves. It suffices to electrically connect the light source 21 (its submount substrate 31) and the board 51, and it is not limited to the configuration of the first embodiment.

As shown in FIG. 4, this heat dissipation member 22 is provided with a pair of positioning projections 53 on the abutment surface 45. The positioning projections 53 are positioned outside of the pair of terminal holes 48 in the left-right directions on the abutment surface 45 and are in a cylindrical shape projecting rearward from the abutment surface 45 in the optical axis direction.

As shown in FIGS. 3 and 4, the heat dissipation member 22 is provided, on the installation plate portion 41, with an annular side surface 54 to make an encirclement in directions perpendicular to the optical axis direction. This side surface 54 (installation plate portion 41) is continuous with the installation surface 43 and has a size that fits into the inside of a peripheral wall 67 of a socket body portion 61 of the socket 23. This side surface 54 is provided with plate-shape portions 55.

The plate-shape portion 55 serves as a location supported by a protrusion portion 73 provided on the socket body portion 61. The plate-shape portions 55 according to the first embodiment are provided at four positions in total by making a pair in the vertical direction and a pair in the left-right direction. In the installation plate portion 41, each plate-shape portion 55 is formed into a plate shape that extends tangentially to a circle centering on the optical axis of the light source 21 and has a smaller dimension (hereinafter may be referred to as thickness) in the optical axis direction than those of other parts of the installation plate portion 41. In the installation plate portion 41, each plate-shape portion 55 has a configuration in which a side of the installation surface 43 is partially cut out. Therefore, the plate-shape portions 55 are formed with partially recessed areas at four locations of both edge portions in the vertical direction and both edge portions in the left-right direction of the installation surface 43 in the installation plate portion 41.

The socket 23 is formed by a material with thermal conductivity. In the first embodiment, it is formed by a resin member. As shown in FIGS. 3 and 5, the socket 23 includes the socket body portion 61 and a socket heat-dissipation portion 62. It (mainly the socket heat-dissipation portion 62) has a function of dissipating heat transferred from the heat dissipation member 22 to the outside. The socket body portion 61 is formed, on the front side in the optical axis direction, with an attachment surface 63 and, on the opposite side (rear side in the optical axis direction), with a back surface 64 (see FIGS. 9 and 10) that is continuous with the socket heat-dissipation portion 62. The socket body portion 61 is formed with a receptive recess 65 prepared by partially making a dent in the attachment surface 63 toward the rear side in the optical axis direction.

The receptive recess 65 is a portion that receives therein the massive portion 42 of the heat dissipation member 22. In the first embodiment, it is a recess conforming to an outer shape of the massive portion 42, that is, it has a shape resulting from inverting the massive portion 42, thereby allowing the massive portion 42 to fit thereinto. This receptive recess 65 is constituted of a receptive wall portion 66 (see FIGS. 9, 10, etc.), and the receptive wall portion 66 has a generally even thickness in its entirety. With this, it is possible to more effectively prevent the receptive recess 65 from having a sink at each part of the receptive wall portion 66, when forming the socket 23 by a resin molding using die. In particular, in the socket 23 of the first embodiment, the receptive wall portion 66 has a thickness that is generally equal to its adjacent parts (after-mentioned peripheral wall 67, flanged wall 68, etc.) (see FIGS. 9 and 10), thereby more effectively preventing the occurrence of sinks at the resin molding.

Furthermore, the socket body portion 61 is a portion that the back surface 64 is continuous with the socket heat-dissipation portion 62, and the back surface 64 is formed into a rear side surface in the optical axis direction of the receptive wall portion 66. Therefore, the socket body portion 61 makes it possible to get the massive portion 42 that fits into the receptive recess 65 and the socket heat-dissipation portion 62 (its each fin 75) close to each other. With this, it is possible to efficiently radiate heat that has been transferred from the heat dissipation member 22 to the socket 23, from the socket heat-dissipation portion 62. In other words, the receptive wall portion 66 is made to have a thickness that allows the massive portion 42 and the socket heat-dissipation portion 62 get close to each other as close as possible while securing the strength of the socket body portion 61.

This socket body portion 61 is provided with the peripheral wall 67 cylindrical in shape and the flanged wall 68 that projects therefrom to the outside along a plane perpendicular to the optical axis direction. The peripheral wall 67 is cylindrical in shape with an outer diameter slightly smaller than an inner diameter of the attachment hole 11a of the lamp housing 11 and positions the receptive recess 65 inside. The peripheral wall 67 is provided with four attachment projections 69 projecting outward in directions perpendicular to the optical axis direction. The four attachment projections 69 are generally equidistantly provided in a circumferential direction of the peripheral wall 67 and are allowed to pass through the notches provided at the edge of the attachment hole 11a of the lamp housing 11. Each attachment projection 69 is brought into abutment with the stopper by changing the rotational posture of the socket body portion 61 relative to the lamp housing 11, thereby making it possible to sandwich a peripheral portion of the attachment hole 11a and the sealing member 15 between each attachment projection 69 and the flanged wall 68 (see FIG. 1). With this, each attachment projection 69 in cooperation with the flanged wall 68 makes it possible to detachably attach the socket 23, that is, the light source unit 20 to the lamp housing 11 through the sealing member 15.

The socket body portion 61 is provided, inside of the peripheral wall 67 on the attachment surface 63, with an installation recess 71, positioning holes 72, and the protrusion portions 73. The installation recess 71 is a place for installing the feed member 24 (see FIG. 3) and is formed by partially making a dent below the receptive recess 65 on the attachment surface 63, toward the rear side in the optical axis direction. This installation recess 71 is provided with a connection hole 74 passing through its back wall. The feed member 24 is one to which a connector 16 (see FIG. 1) on a power source side is connected in a mechanically detachable manner and in an electrically breakable manner, and supplies the electric power from the connector 16 to the light source unit 20. This feed member 24 includes a pair of pin terminals 24a, and this pin terminal 24a is electrically connected to each terminal connection hole 51b, thereby making it possible to supply the electric power to the board 51 (see FIG. 2). The installation recess 71 has a shape conforming to an outer shape of the feed member 24, and insulation of the feed member 24 is secured by fitting the feed member 24 thereinto through an insulating material. This installation recess 71 communicates with an attachment point (its inside) provided on the back surface 64 via the connection hole 74. By providing the feed member 24 in the installation recess 71, a coupling terminal on the back side in the optical axis direction is exposed in the attachment point through the connection hole 74. When the connector 16 (see FIG. 1) on the power source side is attached to the attachment point, the coupling terminal is electrically connected to a coupling terminal of the connector 16.

The positioning holes 72 make a pair on both outer sides of the installation recess 71 in the left-right directions on the attachment surface 63 and are formed into holes extending rearward in the optical axis direction. The positioning holes 72 correspond to the pair of positioning projections 53 of the heat dissipation member 22 and allow each positioning projection 53 to be inserted thereinto. Each positioning hole 72, when the corresponding positioning projection 53 is inserted thereinto, determines a relative position between the heat dissipation member 22 and the socket 23. Therefore, in the first embodiment, the pair of positioning projections 53 of the heat dissipation member 22 becomes a heat-dissipation-side positioning portion, and the pair of positioning holes 72 of the socket 23 becomes a socket-side positioning portion. As long as the heat-dissipation-side positioning portion and the socket-side positioning portion are those to determine a relative position between the heat dissipation member 22 and the socket 23, it suffices to suitably set the positions and the number of them. The projections and the holes may be replaced with each other. It may have other configurations and is not limited to those of the first embodiment.

The protrusion portions 73 are provided for attaching the heat dissipation member 22 to the socket 23 (its socket body portion 61). As shown in FIGS. 3, 5, 9, etc., the protrusion portions 73 are provided by the number of four to respectively correspond to the four plate-shape portions 55 provided on the side surface 54 of the installation plate portion 41 of the heat dissipation member 22. The protrusion portions 73 make one pair in the vertical direction and one pair in the left-right direction and are positioned outside of the receptive recess 65, the installation recess 71 and the positioning holes 72 in a radial direction of a circle centering on the optical axis of the light source 21. Under a condition that the relative position is set by each positioning hole 72 and each positioning projection 53, each protrusion portion 73 has a positional relationship to be adjacent to an outer side in a radial direction of the corresponding plate-shape portion 55 (see FIG. 9, etc.). Each protrusion portion 73 is formed into a plate shape that extends tangentially to a circle centering on the optical axis direction and protrudes from the attachment surface 63 to the front side in the optical axis direction. In each protrusion portion 73, a tip portion 73a is tapered as going to the front side in the optical axis direction and has a cutout shape on its outside in the above-mentioned radial direction in the first embodiment (see FIGS. 5, 9, etc.).

The socket heat-dissipation portion 62 is one for dissipating (radiating) heat transferred from the heat dissipation member 22 to the outside and includes a plurality of fins 75. The fins 75 have a plate shape along a plane perpendicular to the left-right directions and are aligned in the left-right directions while projecting from the back surface 64 to the rear side in the optical axis direction. On this back surface 64, as shown in FIG. 1, at a location not provided with the fins 75, there is provided the attachment point into which the connector 16 on the power source side is inserted. This attachment point is one to which the connector 16 is mechanically detachably attached. When the connector 16 is attached, its coupling terminal is connected to the coupling terminal of the feed member 24 (see FIG. 3, etc.).

This light source unit 20 is assembled, as follows. Firstly, as shown in FIG. 3, the feed member 24 fits into the installation recess 71 of the attachment surface 63 of the socket 23 through an insulating material, and its coupling terminal is exposed in the attachment point from the connection hole 74. On the installation surface 43 of the installation plate portion 41 of the heat dissipation member 22, the light source 21 is attached to the projected surface portion 46 through an adhesive with thermal conductivity, and the board 51 is attached to the installation surface 43 through an adhesive with thermal conductivity such that the light source 21 is surrounded thereby on the underside and both sides in the left-right directions. Upon this, in the board 51, the pair of projection portions 47 on the installation surface 43 is passed through the corresponding opening portions 51a (see FIG. 7), and the terminal connection holes 51b corresponding to the pair of terminal holes 48 on the installation surface 43 are passed through.

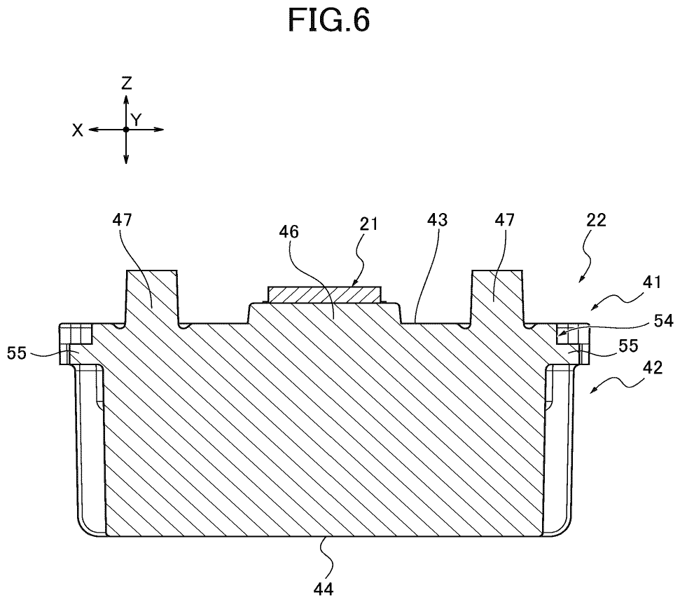

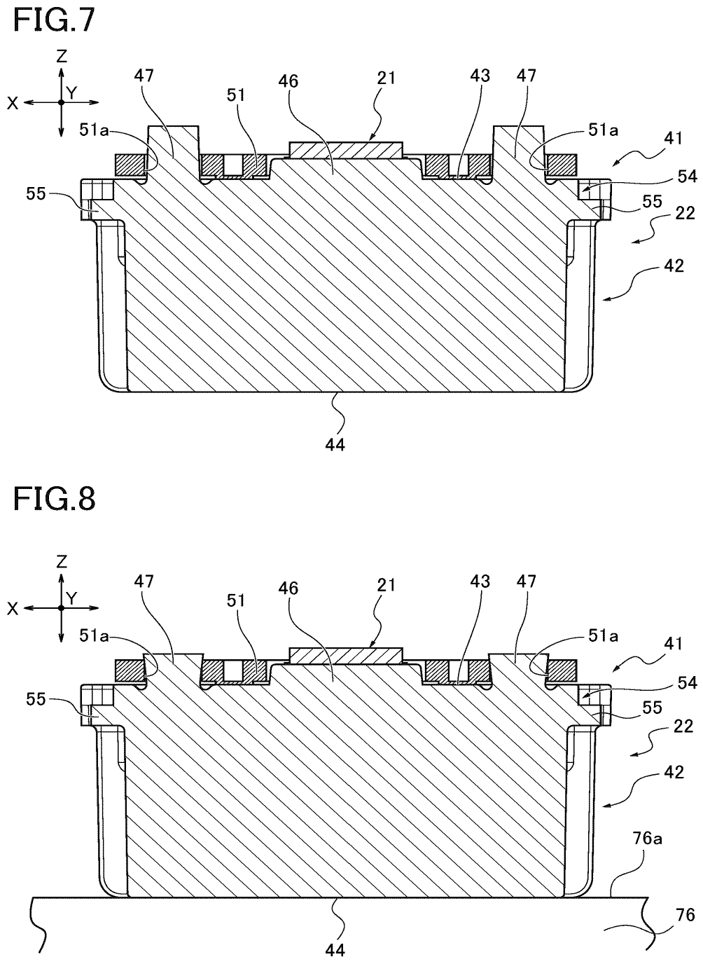

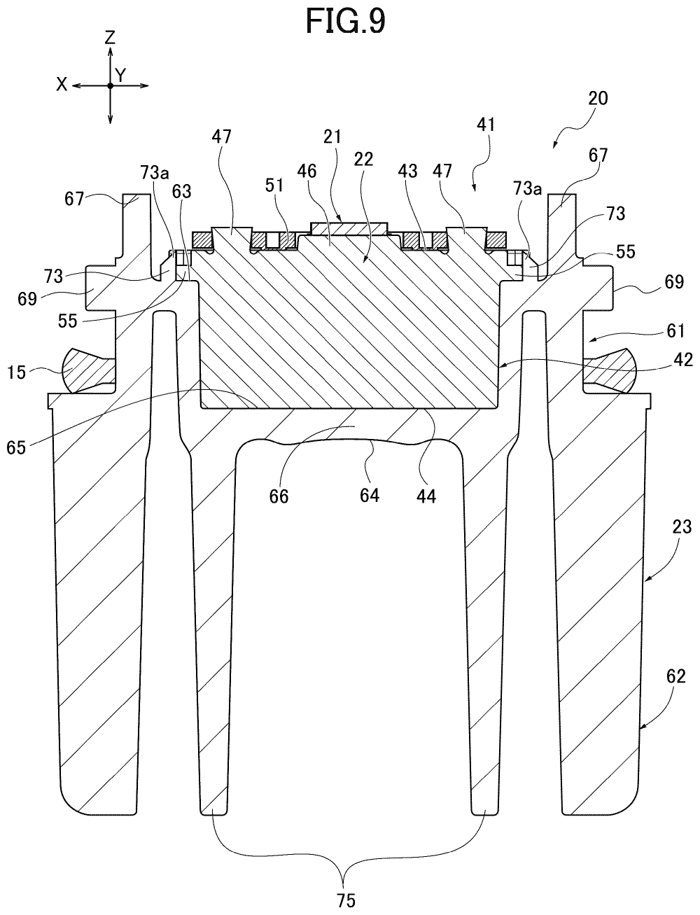

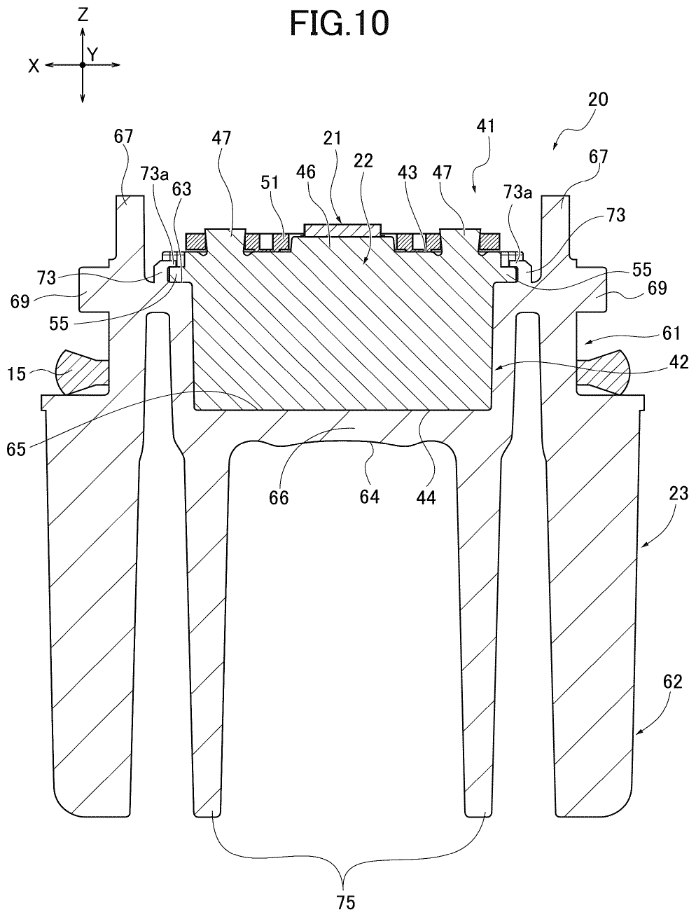

Next, in the heat dissipation member 22, tips of both projection portions 47 are crushed to achieve plastic deformation, that is, swaged (see FIG. 7 before deformation to FIG. 8 after deformation). Herein, the heat dissipation member 22 is provided, on the opposite side of the installation surface 43 in the optical axis direction, with the contact surface 44 that is parallel with the installation surface 43 and flat, and each projection portion 47 is positioned, in the optical axis direction, on the same straight line on which the contact surface 44 is positioned. In the heat dissipation member 22, as shown in FIG. 8, under a condition that the contact surface 44 is placed on a flat working surface 76a of a workbench 76, load is applied to both projection portions 47 (their tips) in the optical axis direction. Upon this, in the heat dissipation member 22, it is possible to allow the applied load to act on between the contact surface 44 (working surface 76a) perpendicular to its direction, thereby efficiently applying the load and allowing the load to evenly act on each projection portion 47 in the optical axis direction. Therefore, the heat dissipation member 22 can suppress deformation of each projection portion 47 in an unintended direction and can stably crush the tips of both projection portions 47. With this, each projection portion 47 is swollen at the tip in a condition that it has been passed through the corresponding opening portion 51a, and is prevented from coming off the opening portion 51a. With this, the board 51 is firmly fixed to the installation surface 43, that is, the heat dissipation member 22.

Next, the pair of bonding wires 52 is disposed to bridge each connection terminal 31b of the submount substrate 31 of the light source 21 and each connection terminal 51c of the board 51. Then, both ends of each bonding wire 52 in abutment with each connection terminal 31b and each connection terminal 51c are electrically connected by wire bonding using ultrasonic waves. Upon this, since the light source 21 is provided on the projected surface portion 46 that has generally the same height as that of the board 51, its position is higher than the board 51. This can facilitate the connection work of both ends of each bonding wire 52.

Next, a heat conductive grease for improving thermal conductivity is provided into the receptive recess 65 of the attachment surface 63 of the socket body portion 61 of the socket 23. Then, inside the peripheral wall 67 of the socket body portion 61, each positioning projection 53 of the heat dissipation member 22 is inserted into the corresponding positioning hole 72, and the massive portion 42 of the heat dissipation member 22 is pressed into the receptive recess 65. Upon this pressing, it is possible to suitably use ultrasonic waves. That is, ultrasonic waves may or may not be used. Upon this, due to an action of positioning between each positioning projection 53 and each positioning hole 72, the massive portion 42 is properly fit into the receptive recess 65, and each pin terminal 24a of the feed member 24 provided in the installation recess 71 of the socket body portion 61 is passed through the corresponding terminal connection hole 51b of the board 51 via the corresponding terminal hole 48 of the installation plate portion 41 of the heat dissipation member 22. Furthermore, due to the above positioning action, each protrusion portion 73 of the socket body portion 61 is positioned to be adjacent to an outer side in a radial direction of the corresponding plate-shape portion 55 of the side surface 54 of the installation plate portion 41 (see FIG. 9, etc.).

Next, the tip portion 73a of each protrusion portion 73 is crushed to achieve plastic deformation, that is, swaged (see FIG. 9 before deformation to FIG. 10 after deformation). Upon this, each protrusion portion 73 is subject to plastic deformation by bending the tip portion 73a inwardly in the radial direction such that the tip portion 73a covers the corresponding plate-shape portion 55 from the front side in the optical axis direction. This swaging may be thermal swaging conducted by adding heat or ultrasonic swaging conducted by using ultrasonic waves. With this, each protrusion portion 73 can clamp the plate-shape portion 55 between its tip portion 73a and the attachment surface 63 on which it is provided (see FIG. 10). Each protrusion portion 73 is positioned to be adjacent to an outer side in the radial direction of the corresponding plate-shape portion 55, and the tip portion 73a is bent inwardly in the radial direction. Thus, the installation plate portion 41 is supported at four locations, thereby achieving a firm fixation to the socket body portion 61. Then, each pin terminal 24a is electrically connected to the terminal connection hole 51b by using solder, etc., thereby assembling the light source unit 20.

This light source unit 20, in a condition that the sealing member 15 is provided in a manner to surround the peripheral wall 67 and to be in abutment with the flanged wall 68, is inserted into the attachment hole 11a of the lamp housing 11 from the side of the light source 21, and each attachment projection 69 of the socket 23 is passed through the notch provided at the edge of the attachment hole 11a. Then, the light source unit 20 is attached to the lamp housing 11, under a condition that the sealing member 15 is clamped between the flanged wall 68 and the peripheral portion of the attachment hole 11a, as a result of bringing each attachment projection 69 into abutment with the stopper by changing the rotational posture of the socket body portion 61 relative to the lamp housing 11. The reflector 13 and the lamp lens 12 are attached to the lamp housing 11, thereby assembling the vehicular lamp 10 (see FIG. 1). In the vehicular lamp 10, the light source 21 and the board 51 in the light source unit 20 are in the light chamber 14 after passing through the attachment hole 11a of the lamp housing 11 and the attachment hole 13b of the reflector 13 and are disposed on the side of the reflective surface 13a of the reflector 13. The vehicular lamp 10 becomes capable of supplying power to the board 51 via the feed member 24 by attaching the connector 16 on the power source side to the attachment point of the socket 23 of the light source unit 20 attached to the lamp housing 11. This makes it possible to turn the light source 21 on and off as needed.

In this vehicular lamp 10, the light source 21 is provided on the heat dissipation member 22 formed by a metal die casting (aluminum die casting in the first embodiment). Therefore, compared with using a thin plate-shape metal body like the conventional technology of Patent Literature 1, it is possible to increase thermal capacity of the heat dissipation member 22, thereby properly cooling the light source 21. In addition, the vehicular lamp 10 can efficiently increase thermal capacity, since, in the heat dissipation member 22, the massive portion 42 is formed into a prismatic shape that projects toward the rear side from the installation plate portion 41. In particular, in the vehicular lamp 10, the massive portion 42 of the heat dissipation member 22 fits into the receptive recess 65 of the socket 23. Therefore, it is possible to efficiently transfer heat generated at the light source 21 from the heat dissipation member 22 to the socket 23 and to make the heat escape from the socket 23 to the outside.

In addition, in the vehicular lamp 10, the heat dissipation member 22 is such that the massive portion 42 is formed into a prismatic shape projecting from the installation plate portion 41 toward the rear side and that the contact surface 44 on its rear side is formed into a flat surface perpendicular to the optical axis direction and parallel with the installation surface 43. Therefore, even if the projected area in the optical axis direction of the massive portion 42 is made equal to that of the conic metal body of the conventional technology of Patent Literature 2, the vehicular lamp 10 makes it possible to cause the volume of the massive portion 42 to be larger than that of the metal body, thereby increasing thermal capacity of the heat dissipation member 22. The vehicular lamp 10 is such that the socket 23 is also provided with the socket heat-dissipation portion 62 (each fin 75). Therefore, it is possible to efficiently radiate heat transferred from the heat dissipation member 22 to the socket 23, thereby accelerating heat dissipation of the heat dissipation member 22. Therefore, the vehicular lamp 10 can more properly cool the light source 21, as compared with the conventional technologies of Patent Literatures 1 and 2, thereby properly turning the light source 21 on.

In addition, since the vehicular lamp 10 makes the massive portion 42 of the heat dissipation member 22 have a prismatic shape, the heat dissipation member 22 increases in weight. Thus, it may become difficult to maintain a condition of fixing the heat dissipation member 22 to the socket 23. However, the vehicular lamp 10 swages the protrusion portions 73 of the socket 23 to support the plate-shape portions 55 of the heat dissipation member 22, thereby properly fixing the heat dissipation member 22 to the socket 23. In particular, the vehicular lamp 10 of the first embodiment is provided with the plate-shape portions 55 at four locations in total by making one pair in the vertical direction and one pair in the left-right direction. Therefore, it is possible to fix the heat dissipation member 22 with good balance and to more properly maintain a condition of fixing the heat dissipation member 22 to the socket 23. In addition, the vehicular lamp 10 causes the massive portion 42 of the heat dissipation member 22 to fit into the receptive recess 65 of the socket 23. Therefore, even the heat dissipation member 22 with increased weight can be properly fixed to the socket 23, and it is possible to efficiently transfer heat generated at the light source 21, from the heat dissipation member 22 to the socket 23.

Herein, the vehicular lamps of Patent Literatures 1 and 2 are such that the board is provided on the metal body via a heat conductive medium or joining layer. Therefore, it may be possible that the board comes off or its position deviates due to insufficient attachment strength of the board. Thus, the applicant has considered fixing the board to the metal body by swaging. However, the vehicular lamp of Patent Literature 1 is such that the metal body is integrally embedded in the socket by insert molding. Therefore, when it is intended to fix the board to the metal body by swaging, load is to be applied to the metal body and the socket as an integral object. This may deform or break the socket, and it becomes difficult to allow the swaging load to properly act on the swaging projection. Furthermore, the vehicular lamp of Patent Literature 2 is such that the rear side of the metal body is conic. Therefore, when it is intended to fix the board to the metal body by swaging, it becomes necessary to have a jig, etc., for fixing the metal body when applying the load. Furthermore, the swaging load escapes from an inclined conic side surface. With this, it becomes difficult to allow the load to properly act. Thus, it is difficult in the vehicular lamps of Patent Literatures 1 and 2 to properly fix the board to the metal body, even when it is intended to fix the board to the metal body by swaging.

In contrast with this, the vehicular lamp 10 is such that, in the heat dissipation member 22, the installation surface 43 and the contact surface 44 on the opposite side in the optical axis direction are formed into flat surfaces, and each projection portion 47 on the installation surface 43 and the contact surface 44 (its portion) are positioned on the same straight line. Therefore, the vehicular lamp 10 is such that the load in the optical axis direction is applied to both projection portions 47 in a condition that the contact surface 44 is placed on a flat surface (working surface 76a in the first embodiment), thereby making it possible to stably crush the tips of both projection portions 47. With this, as compared with the vehicular lamps of Patent Literatures 1 and 2, the vehicular lamp 10 can properly fix the board 51 to the heat dissipation member 22.

Furthermore, the vehicular lamp 10 is affected by vehicle vibration when mounted on a vehicle, and electrically connects the light source 21 and the board 51 with the pair of bonding wires 52 by wire bonding using ultrasonic waves. Therefore, the vehicular lamp 10 may have a risk that the board comes off or its position deviates when conducting wire bonding using ultrasonic waves. For this too, the vehicular lamp 10 is such that the board 51 is fixed in advance to the heat dissipation member 22 by swaging, thereby properly maintaining a condition of fixing the board 51 to the heat dissipation member 22. In addition, the vehicular lamp 10 can expose a configuration that the board 51 is fixed to the heat dissipation member 22 by swaging. Therefore, it is possible at a glance to confirm that the board 51 is firmly fixed.

The vehicular lamp 10 of the first embodiment can obtain each of the following advantageous effects.

The vehicular lamp 10 is such that the heat dissipation member 22 includes the projection portion 47 that projects from the installation surface 43 and the contact surface 44 that is brought into abutment with the attachment surface 63, that the board 51 includes the opening portion 51a that allows the projection portion 47 to pass therethrough, and that the contact surface 44 as a flat surface on the opposite side of the installation surface 43 is positioned, in the optical axis direction, on the same straight line on which the projection portion 47 is positioned. Therefore, the vehicular lamp 10 can stably crush the tip of the projection portion 47 by applying the load in the optical axis direction to the projection portion 47 under a condition that the contact surface 44 is placed on a flat surface. The vehicular lamp 10 has a configuration that the heat dissipation member 22 for dissipating heat from the light source 21 is attached to the socket 23, thereby securing thermal conductivity in the heat dissipation member 22. With this, the vehicular lamp 10 can properly fix the board 51 to the heat dissipation member 22 and sufficiently cool the light source 21.

Furthermore, the vehicular lamp 10 is such that the contact surface 44 is formed into a flat surface perpendicular to the optical axis direction. Therefore, the vehicular lamp 10 can allow the load in the optical axis direction to the projection portion 47 to properly act on between the contact surface 44, thereby evenly crushing the projection portion 47 in the optical axis direction.

Furthermore, the vehicular lamp 10 is such that the heat dissipation member 22 includes the annular side surface 54 that is continuous with the installation surface 43, that the socket 23 includes the protrusion portion 73 protruding from the attachment surface 63, and that the heat dissipation member 22 is provided, on the side surface 54, with the portion 55 supported by the protrusion portion 73. Thus, the vehicular lamp 10 is such that the protrusion portion 73 clamps the plate-shape portion 55 of the side surface 54 of the heat dissipation member 22, thereby making it possible to achieve the fixation without positioning the protrusion portion 73 on the installation surface 43. With this, the vehicular lamp 10 can properly fix even the heat dissipation member 22, which is provided, on the installation surface 43, with the light source 21 and the board 51, to the socket 23, thereby sufficiently cooling the light source 21.

The vehicular lamp 10 is such that the socket 23 includes the receptive recess 65 that receives the heat dissipation member 22, that the receptive recess 65 is formed by partially recessing the attachment surface 63, and that the receptive wall portion 66 that constitutes the receptive recess 65 has substantially even thickness in an entirety thereof. Therefore, the vehicular lamp 10 can more effectively prevent the occurrence of sinks at a resin molding of the socket 23. With this, it is possible to properly fit the heat dissipation member 22 into the receptive recess 65 and sufficiently cool the light source 21.

The vehicular lamp 10 is such that the light source 21 is a submount-type light emitting device, and that the installation surface 43 includes a light source installation location (the projected surface portion 46 in the first embodiment) and a board installation location (the underside and both sides in the left-right direction of the projected surface portion 46 on the installation surface 43 in the first embodiment) where the board 51 is installed. The vehicular lamp 10 provides the projection portion 47 as a pair at a position where the light source installation location is interposed therebetween, in the board installation location. With this, the vehicular lamp 10 can stably fix the board 51, which is electrically connected to the light source 21, to the heat dissipation member 22.

The vehicular lamp 10 positions the light source 21, which is installed on the light source installation location, at a position equal to or higher in the optical axis direction than the board 51, which is installed on the board installation location. Therefore, the vehicular lamp 10 makes it easy to conduct a connection work of both ends of each bonding wire 52 that bridges the light source 21 (its each connection terminal 31b) and the board 51 (its each connection terminal 51c).

Therefore, the vehicular lamp 10 of the first embodiment as a vehicular lamp according to the present disclosure allows heat from the light source 21 to escape sufficiently, while securing the attachment strength of the board 51 to the heat dissipation member 22.

As above, the vehicular lamp of the present disclosure has been described, based on the first embodiment, but specific configurations are not limited to the first embodiment. Design changes, additions, etc. are permitted, as long as they do not deviate from the gist of the invention according to each claim in the claims.

In the first embodiment, the heat dissipation member 22 is formed by aluminum die casting. However, the heat dissipation member is not limited to the configuration of the first embodiment, as long as it is one that is formed by a metal die casting and that has a thickness greater than that of a thin plate-shape metal body (so-called metal plate). In the first embodiment, in the heat dissipation member 22, the prismatic massive portion 42 is provided at a position biased toward the upper side in the vertical direction relative to the installation plate portion 41. However, as long as the heat dissipation member is formed by a metal die casting, its entirety may be the massive portion 42, or the position of the massive portion 42 may be changed. It is not limited to the configuration of the first embodiment.

Furthermore, in the first embodiment, the projection portion 47 is provided as a pair to interpose the light source 21 (projected surface portion 46) in the left-right direction. However, the projection portion 47 may be suitably set in terms of its position, number or shape, as long as it is one that is provided to project from the installation surface 43 of the heat dissipation member 22, that is capable of passing through the opening portion 51a of the board 51, and that makes the contact surface 44 positioned on the same straight line in the optical axis direction. It is not limited to the configuration of the first embodiment.

Furthermore, in the first embodiment, using the submount-type light source 21, it is electrically connected with the board 51 by a pair of bonding wires 52 provided by wire bonding. However, it suffices as long as the light source is one that is attached to the heat dissipation member 22 and that is, due to supplying power from the power-source-side connector 16 attached to the socket 23, turned on and off as needed. For example, it may be a configuration in which one prepared by mounting a light source on a board is attached to the heat dissipation member 22. Other configurations will do, and it is not limited to the configuration of the first embodiment.

In the first embodiment, the light source installation location is set at the projected surface portion 46 that is prepared by making a center of the installation surface 43 of the heat dissipation member 22 partially project. However, as long as the light source installation location is a location where the light source 21 is provided on the installation surface 43, it may be a flat surface flush with the installation surface 43, or it may project in an area larger than the light source 21. It is not limited to the configuration of the first embodiment. Herein, since the connection work of both ends of each bonding wire 52 bridging the light source 21 and the board 51 can be made easy, it is desirable to make the light source installation location such that the light source that is installed thereon is at a position equal to or higher in the optical axis direction than the board 51 that is installed on the board installation location.

1. A vehicular lamp comprising:
a board that is electrically connected to a light source; and
a heat dissipation member for dissipating heat from the light source, comprising an installation surface on which the board is placed,
wherein the heat dissipation member further comprises a projection portion that projects from the installation surface and a contact surface that is opposite to the installation surface and is formed into a flat surface,
wherein the board comprises an opening portion that allows the projection portion to pass therethrough, and
wherein the contact surface is positioned, in an optical axis direction, on a same straight line on which the projection portion is positioned.

2. The vehicular lamp according to claim 1, wherein the contact surface is formed into the flat surface that is perpendicular to the optical axis direction.

3. The vehicular lamp according to claim 1, further comprising a socket to which the heat dissipation member is attached,
wherein the socket comprises an attachment surface on which the contact surface is placed.

4. The vehicular lamp according to claim 3, wherein the heat dissipation member comprises an annular side surface that is continuous with the installation surface,
wherein the socket comprises a protrusion portion for fixing the heat dissipation member, the protrusion portion projecting from the attachment surface, and
wherein the heat dissipation member is provided, on the side surface, with a plate-shape portion that serves as a location supported by the protrusion portion.

5. The vehicular lamp according to claim 3, wherein the socket comprises a receptive recess that receives the heat dissipation member,
wherein the receptive recess is formed by partially recessing the attachment surface, and a receptive wall portion that constitutes the receptive recess has a substantially even thickness in an entirety thereof.

6. The vehicular lamp according to claim 1, wherein the light source is a submount-type light emitting device,
wherein the installation surface comprises a light source installation location where the light source is installed, and a board installation location where the board is installed, and
wherein the projection portion is provided as a pair at a position where the light source installation location is interposed therebetween, in the board installation location.

7. The vehicular lamp according to claim 6, wherein the light source installation location is such that the light source that is installed is at a position equal to or higher in the optical axis direction than the board that is installed on the board installation location.

8. The vehicular lamp according to claim 4, wherein the socket comprises a receptive recess that receives the heat dissipation member,
wherein the receptive recess is formed by partially recessing the attachment surface, and a receptive wall portion that constitutes the receptive recess has a substantially even thickness in an entirety thereof.
